(19) United States
(12) Patent Application Publication
(10) Pub. No.: US 2023/0344211 A1
(43) Pub. Date: Oct. 26, 2023

(54) CABLE HOUSING CONTAINER

(71) Applicant: FURUKAWA ELECTRIC CO., LTD., Tokyo (JP)

(72) Inventors: Koichi MAENO, Tokyo (JP); Takuya MAKI, Tokyo (JP)

(73) Assignee: FURUKAWA ELECTRIC CO., LTD., Tokyo (JP)

(21) Appl. No.: 18/344,935

(22) Filed: Jun. 30, 2023

Related U.S. Application Data
(63) Continuation of application No. PCT/JP2022/036729, filed on Sep. 30, 2022.

(30) Foreign Application Priority Data
Oct. 1, 2021 (JP) 2021-163063

(51) Int. Cl. H02G 9/06; H02G 3/04

(52) U.S. Cl. CPC H02G 9/06; H02G 3/0406

(57) ABSTRACT

Provided is a cable housing container that allows compaction to be reliably performed around a container body when the container body is buried. The cable housing container 1 includes a container body 10 provided with a bottom portion 11 and a pair of side wall portions 12 extending upward from both sides in a width direction of the bottom portion 11 and having an opening 10a formed on an upper surface thereof, the container body 10 being made of resin and being adapted to be buried in a ground. Each of the pair of side wall portions 12 of the container body 10 has, on its outer surface, an overhanging portion 14 that is formed on an upper portion of the outer surface and overhangs outward in the width direction of the container body 10 relative to a lower portion of the outer surface, and a plurality of reinforcing ribs 15 that are formed below the overhanging portion 14 and spaced apart from each other in a horizontal direction, each of the reinforcing ribs protruding outward in the width direction and extending in a top-bottom direction. The overhanging portion 14 has, on its lower portion, an inclined surface 14a formed in such a manner as to gradually downwardly decrease in an outward overhang amount in the width direction of the container body 10.

### TECHNICAL FIELD

The present invention relates to a cable housing container that houses cables laid under the ground of a road.

### BACKGROUND ART

Conventionally, there is known a cable housing container including a resin container body provided with a bottom portion and a pair of side wall portions extending upward from both sides in a width direction of the bottom portion and having an opening formed in an upper surface thereof (for example, see Patent Document 1).

The container body of the cable housing container disclosed in Patent Document 1 is adapted to be installed on the ground and to house cables extending along, for example, a railroad track, and is not adapted to be buried in the ground. For this reason, according to the cable housing container disclosed in Patent Document 1, strength of the container body may be insufficient when the container body is buried in the ground.

Therefore, for a cable housing container including a container body to be buried in the ground, it is conceivable to form a reinforcing structure such as ribs on an outer surface of a resin container body.

Patent Document 1: Japanese Unexamined Patent Application, Publication No. 2007-132007

### DISCLOSURE OF THE INVENTION

### Problems to be Solved by the Invention

In a case of burying a container body in the ground, the container body is installed in a gutter formed by removal of soil, and sand or gravel is put into both widthwise outside spaces of the container body and is compacted with a compaction machine such as a tamper. For this reason, in a case of burying a container body having a reinforcing structure in the ground, even if sand or crushed stone is put into both widthwise outside spaces of the container body and is compacted with a compaction machine, it is possible that the sand or gravel hardly enter a recess of the reinforcing structure formed on the outer surface. In such a case, when the container body buried in the ground is used for a long period of time, sand or gravel may enter the recess of the reinforcing structure and cause the ground around the buried container body to subside.

An object of the present invention is to provide a cable housing container that allows compaction to be reliably performed around a container body when the container body is buried.

### Means for Solving the Problems

The present invention provides a cable housing container including a container body provided with a bottom portion and a pair of side wall portions extending upward from both sides in a width direction of the bottom portion and having an opening formed on an upper surface thereof, the container body being made of resin and being adapted to be buried in a ground. Each of the pair of side wall portions of the container body has, on an outer surface thereof, an overhanging portion that is formed on an upper portion of the outer surface and overhangs outward in the width direction of the container body relative to a lower portion of the outer surface, and a plurality of reinforcing ribs that are formed below the overhanging portion and spaced apart from each other in a horizontal direction, each of the reinforcing ribs protruding outward in the width direction and extending in a top-bottom direction. The overhanging portion has, on a lower portion thereof, an inclined surface formed in such a manner as to gradually downwardly decrease in an outward overhang amount in the width direction of the container body.

In the cable housing container according to the present invention, the inclined surface has an angle of 45° or less with respect to a vertical direction.

In the cable housing container according to the present invention, each of the reinforcing ribs has a width that gradually decreases toward an end in a protruding direction.

In the cable housing container according to the present invention, a distance between the reinforcing ribs adjacent to each other is three times or more a protruding amount of the reinforcing ribs.

In the cable housing container according to the present invention, the cable housing container includes a lid that closes the opening of the container body. Each of the pair of side wall portions of the container body has a lid receiving portion that receives the lid, and the lid receiving portion is formed inward in the width direction relative to the overhanging portion.

### Effects of the Invention

According to the present invention, a force of a compaction machine is transmitted obliquely downward along the inclined surface, and thus sand and gravel located below the overhanging portion are compacted with the compaction machine, thereby making it possible to reliably perform compaction around the container body, and to suppress subsidence of the ground around the container body after the installation.

### BRIEF DESCRIPTION OF THE DRAWINGS

FIG. 1 is a schematic diagram of a cable housing container according to an embodiment of the present invention;

FIG. 2 is a cross-sectional view of the cable housing container according to the embodiment of the present invention;

FIG. 3 is a perspective view of a container body according to the embodiment of the present invention;

FIG. 4 is a sectional view of a reinforcing rib according to the embodiment of the present invention;

FIG. 5 is a sectional view illustrating a method of burying the container body according to the embodiment of the present invention in the ground;

FIGS. 6A and 6B is a diagram illustrating a test for demonstrating effectiveness of the container body according to the embodiment of the present invention;

FIG. 7 is a diagram illustrating a test for demonstrating effectiveness of the container body according to the embodiment of the present invention; and

FIGS. 8A and 8B is a table illustrating results of the test for demonstrating the effectiveness of the container body according to the embodiment of the present invention.

### PREFERRED MODE FOR CARRYING OUT THE INVENTION

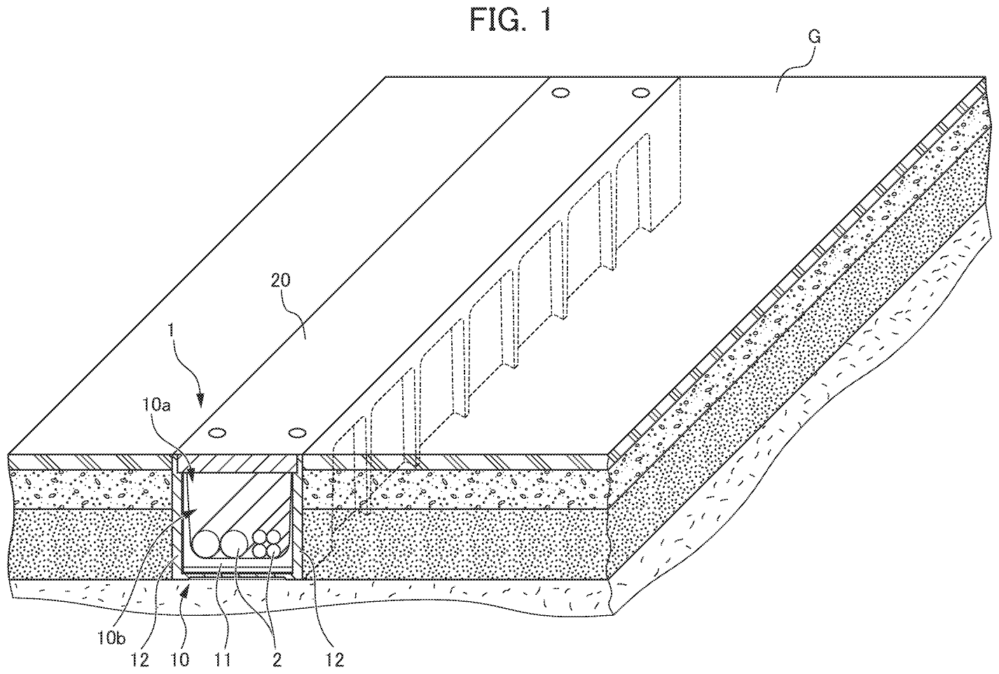

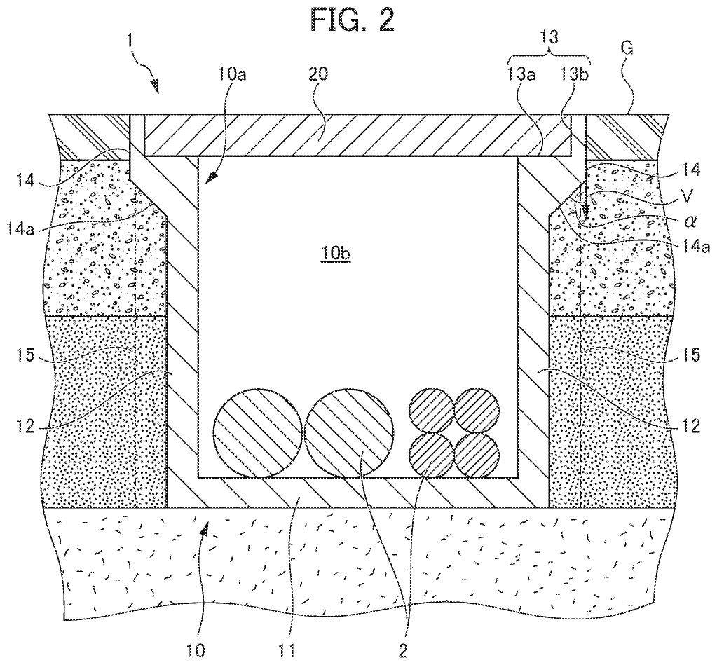

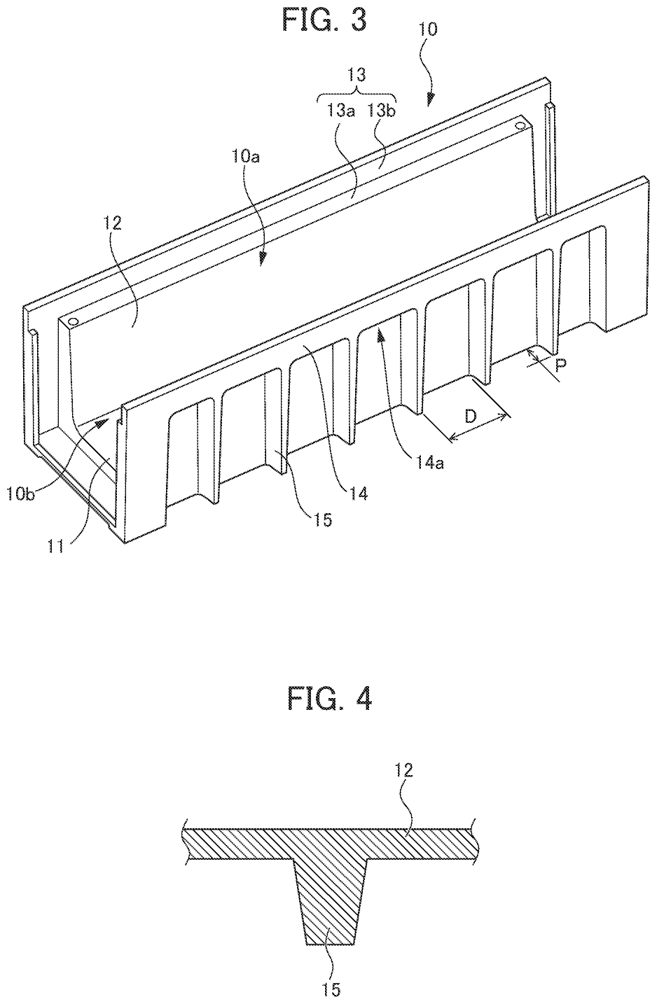

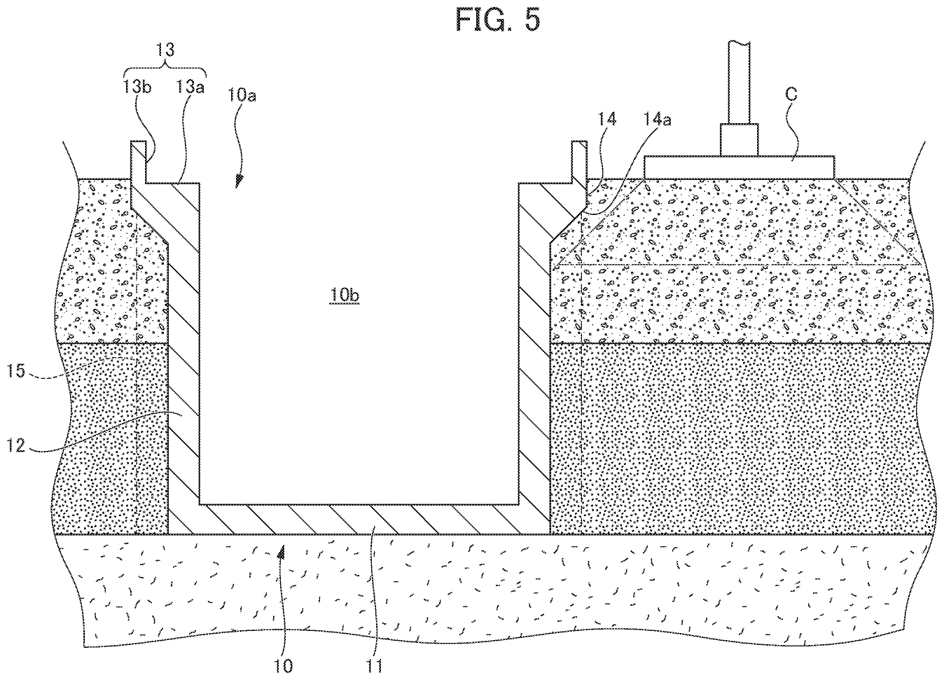

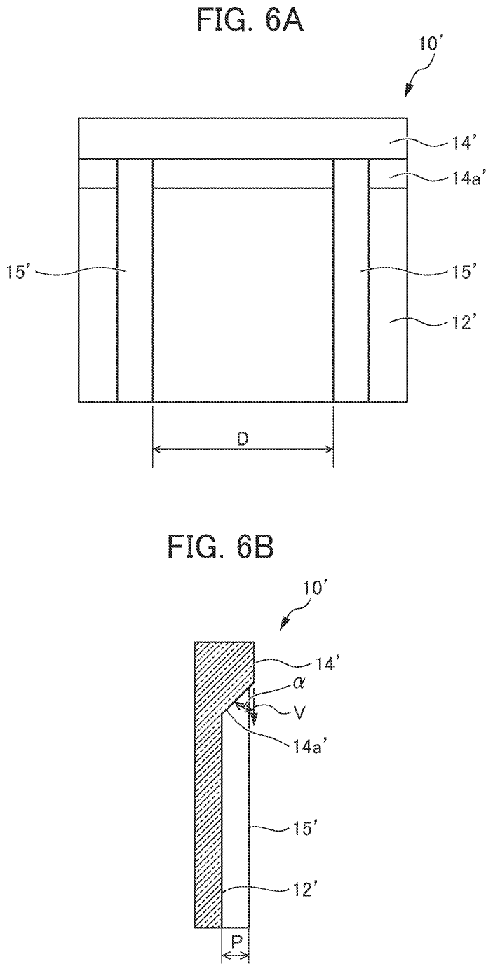

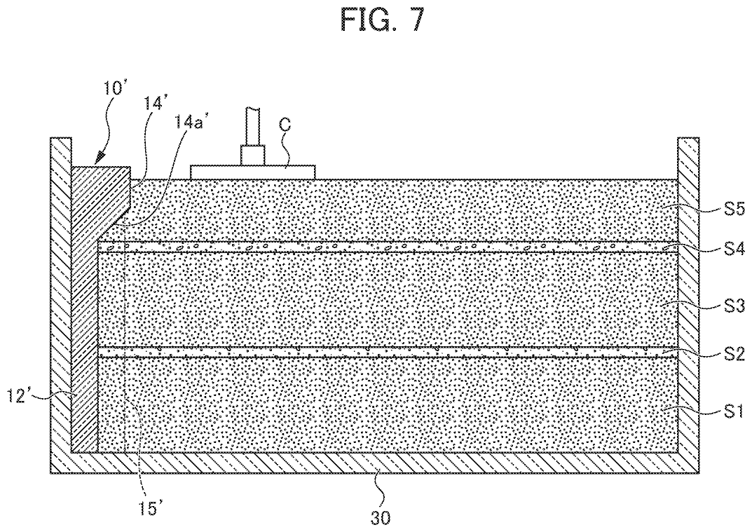

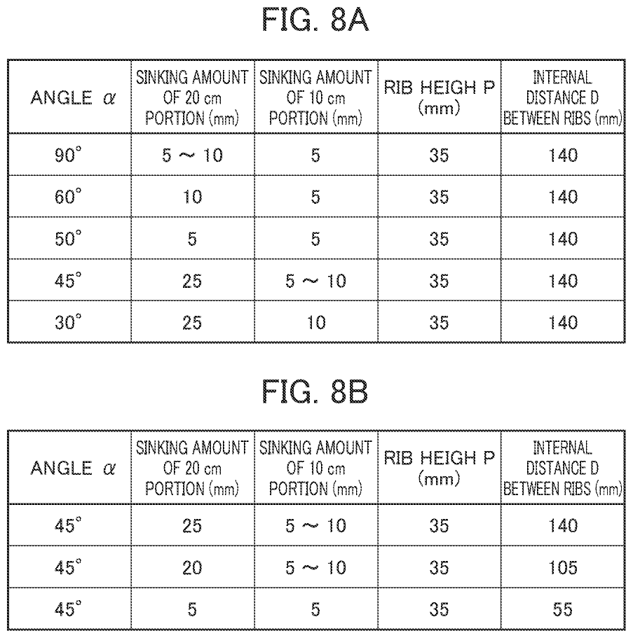

FIGS. 1 to 8 show an embodiment of the present invention. FIG. 1 is a schematic diagram of a cable housing container, FIG. 2 is a cross-sectional view of the cable housing container, FIG. 3 is a perspective view of a container body, FIG. 4 is a sectional view of a reinforcing rib, FIG. 5 is a diagram illustrating a method of burying the container body under the ground, FIGS. 6A and 6B is a diagram illustrating a test for demonstrating effectiveness of the container body, FIG. 7 is a diagram illustrating a test for demonstrating effectiveness of the container body, and FIGS. 8A and 8B is a table illustrating results of the test for demonstrating the effectiveness of the container body.

A cable housing container 1 of the present embodiment is used for housing a plurality of cables 2 including transmission lines or distribution lines through which power supplied from a power plant is fed to each of demand facilities and communication lines through which signals transmitted and received between a plurality of wireless base station devices and switching centers are sent. As shown in FIGS. 1 and 2, the cable housing container 1 is buried in an asphalt—paved road on which vehicles and pedestrians pass such that an upper surface thereof is flush with a road surface G.

As shown in FIGS. 1 and 2, the cable housing container 1 includes a container body 10 having a U-shaped cross section and an opening 10a formed on the upper surface thereof, and a lid 20 that closes the opening 10a of the container body 10.

The container body 10 is made of a resin member. The container body 10 includes a bottom portion 11 formed in a rectangular plate shape and a pair of side wall portions 12 extending upward from both end sides in a width direction of the bottom portion 11, and a portion surrounded by the bottom portion 11 and the pair of side wall portions 12 is a housing space 10b in which the cable 2 is housed. The housing space 10b can be continuously formed in a manner that the container body 10 is connected to another container body 10 in a longitudinal direction.

On tops of the pair of side wall portions 12 of the container body 10, as shown in FIG. 2, lid receiving portions 13 are formed to receive the lid 20. Each of the lid receiving portions 13 includes a lid supporting surface 13a that supports the lid 20 from below and a lid holding surface 13b that faces an end in the width direction of the lid 20 to hold the lid 20.

In addition, each of the pair of side wall portions 12 has, on its outer surface, an overhanging portion 14 that is formed on an upper portion of the outer surface and overhangs outward in the width direction relative to a lower portion of the outer surface, due to the formation of the lid receiving portion 13. On a lower portion of each of the overhanging portions 14, an inclined surface 14a is formed in which the outward overhang amount in the width direction gradually decreases toward the lower portion of the side wall portion. An angle α of the inclined surface 14a is 45° or less with respect to a vertical direction V.

Further, on outer surfaces of the pair of side wall portions 12, as shown in FIGS. 2 and 3, a plurality of reinforcing ribs 15 spaced apart in a longitudinal direction are formed to improve strength of the container body 10. The reinforcing ribs 15 are formed below the overhanging portion 14 so as to protrude outward in the width direction and extend in a top-bottom direction. As shown in FIG. 4, each of the reinforcing ribs 15 is preferably formed in a trapezoidal cross-sectional shape in which a size in the width direction gradually decreases from a base end located on an inner side in the width direction toward a tip located on an outer side in the width direction. Here, a distance D between the reinforcing ribs 15 adjacent to each other on the outer surface of each of the pair of side wall portions 12 is three times or more the protruding amount P of the reinforcing rib 15, as shown in FIG. 3.

As shown in FIGS. 1 and 2, the lid 20 is made of a rectangular resin plate-like member. The lid 20 is formed in which a size in the longitudinal direction is equal to a size in the longitudinal direction of the container body 10 and a size in the width direction is slightly smaller than a distance between the opposing lid holding surfaces 13b of the lid receiving portion 13 of the container body 10. The lid 20 is detachably fixed to the container body 10 by a fastening member (not shown).

When the cable housing container 1 configured as described above is installed, the container body 10 is installed in a state where the installation place and the surrounding soil are removed. The container body 10 installed at the installation place is buried in a state where sand and gravel are put around the installation place in this order and are rolled and compacted using a compaction machine C such as a tamper and then asphalt is paved on the gravel.

The overhanging portion 14 located on the upper portion of the outer surface of the side wall portion 12 of the container body 10 overhangs further outward in the width direction than the lower portion. For this reason, even when the sand and the gravel put around the container body 10 are rolled and compacted by the compaction machine C during burying of the container body 10, it is conceivable that a force of the compaction machine C is hardly transmitted to the sand and the gravel located below the overhanging portion 14 of the side wall portion 12, resulting in insufficient compaction. However, on the lower portion of the overhanging portion 14, the inclined surface 14a is formed in such a manner as to gradually downwardly decrease in the overhang amount, vibration and a pressing force of the compaction machine C is also transmitted obliquely downward as shown in FIG. 5, whereby the force of the compaction machine C is also transmitted to the sand and the gravel located below the overhanging portion 14, and the sand and the gravel are compacted.

Further, when the reinforcing rib 15 is formed such that the dimension in the width direction gradually decreases in the protruding direction, sand and gravel are likely to enter both outer sides in the width direction of the reinforcing rib 15. In addition, since the reinforcing ribs 15 are disposed such that the distance D between the reinforcing ribs 15 adjacent to each other on the outer surface of each of the pair of side wall portions 12 is three times or more the protruding amount P of the reinforcing ribs 15, the force of the compaction machine C is reliably transmitted to the sand and the gravel located between the reinforcing ribs 15 of the side wall portion 12. In addition, since the compacted sand and gravel are located around the reinforcing ribs 15 that protrude outward in the width direction from the outer surface of the side wall portion 12, displacement in the longitudinal direction of the container body 10 is reduced or prevented.

Here, a description will be given with reference to FIGS. 6A, 6B and 7 with respect to a test for demonstrating effectiveness of the angle α of the inclined surface 14a with respect to the vertical direction and a relationship between the protruding amount P of the reinforcing rib 15 and the distance D between the reinforcing rib 15 and the adjacent reinforcing rib 15.

In the test, as shown in FIGS. 6A and 6B, a test model 10′ is used which is a partial model of the side wall portion 12 of the container body 10.

The test model 10′ is made of a transparent resin member, and includes a side wall portions 12′ corresponding to the side wall portion 12 of the container body 10, an overhanging portion 14′ corresponding to the overhanging portion 14, an inclined surface 14a′ corresponding to the inclined surface 14a, and a pair of reinforcing ribs 15′ corresponding to the reinforcing ribs 15.

Further, the test model 10′ is formed with the inclined surface 14a′ such that the inclined surface 14a′ forms an angle α with respect to the vertical direction V. Each of the pair of reinforcing ribs 15′ protrudes from the side wall portion 12′ by the protruding amount P, and are spaced apart by a distance D from each other.

In the test, five test models 10′ are used in order to demonstrate the effective angle α of the inclined surface 14a with respect to the vertical direction V, each test model being configured in which the protruding amount P of each of the pair of reinforcing ribs 15′ is 35 mm, the distance D is 140 mm, and the angle α of the inclined surface 14a with respect to the vertical direction V is 30°, 45°, 50°, 60°, or 90°.

In the test, three test models 10′ are used in order to demonstrate the effective relationship between the protruding amount P of the reinforcing rib 15 and the distance D between the reinforcing ribs 15 adjacent to each other, each test model being configured in which the angle α of the inclined surface 14a′ with respect to the vertical direction V is 45°, the protruding amount P of each of the pair of reinforcing ribs 15′ is 35 mm, and the distance D is 55 mm, 105 mm, or 140 mm.

In the test, as shown in FIG. 7, an enclosure 30 made of a transparent resin is used that includes a bottom portion and four wall portions surrounding an outer periphery of the bottom portion, and has an upper surface opened.

In the test, with the test model 10′ installed on inner surfaces of the wall portions of the enclosure 30, river sand is put into the enclosure 30 to a height of 10 cm from the bottom portion to form a first river sand layer S1, white sand different in color from the river sand is put on the first river sand layer S1 as a whole to form a first white sand layer S2, river sand is put on the first white sand layer S2 to a height of 20 cm from the bottom portion of the enclosure 30 to form a second river sand layer S3, white sand is put on the second river sand layer S3 as a whole to form a second white sand layer S4, and river sand is put on the second white sand layer S4 to form a third river sand layer S5.

In the test, the river sand and the white sand are compacted with the compaction machine C in a state where the first river sand layer S1, the first white sand layer S2, the second river sand layer S3, the second white sand layer S4, and the third river sand layer S5 are formed, and a downward sinking amount of the first white sand layer S2 and the second white sand layer S4 located near the test model 10′ is measured from the outside of the enclosure 30.

The above-described test is performed for each of the test models 10′ to measure the sinking amount of the first white sand layer S2 and the second white sand layer S4 in each of the test models 10′, whereby the effective angle α of the inclined surface 14a with respect to the vertical direction V is confirmed, and the effective relationship between the protruding amount P of the reinforcing rib 15 and the distance D between the reinforcing rib 15 and the adjacent reinforcing rib 15 is confirmed.

Regarding the effective angle α of the inclined surface 14a′ with respect to the vertical direction V, as shown in FIG. 8A, compared to a case where the angles α are 50°, 60°, and 90°, the sinking amount of the first white sand layer S2 and the second white sand layer S4 is greater when the angles are 30° and 45°. In other words, in the test, when the angle α of the inclined surface 14a′ with respect to the vertical direction V is greater than 45°, it can be seen that the force of the compaction machine C is hardly transmitted to the sand located below the overhanging portion 14′ and the sinking amount of the first white sand layer S2 and the second white sand layer S4 becomes smaller. Further, when the angle α is 45° or less, it can be seen that the force of the compaction machine C is easily transmitted to the sand located below the overhanging portion 14′ and the sinking amount of the first white sand layer S2 and the second white sand layer S4 becomes greater.

In addition, regarding the effective relationship between the protruding amount P of the reinforcing rib 15 and the distance D between the reinforcing rib 15 and the adjacent reinforcing rib 15, as shown in FIG. 8B, compared to a case where the distance D is less than three times the protruding amount P, the sinking amount of the first white sand layer S2 and the second white sand layer S4 is greater when the distance D is three times or more the protruding amount P. In other words, in the test, when the distance D is less than three times the protruding amount P, it can be seen that the force of the compaction machine C is hardly transmitted to the sand located between the reinforcing rib 15′ and the reinforcing rib 15′ and the sinking amount of the first white sand layer S2 and the second white sand layer S4 becomes smaller. Further, when the distance D is three times or more the protruding amount P, it can be seen that the force of the compaction machine C is easily transmitted to the sand located between the reinforcing rib 15′ and the reinforcing rib 15′ and the sinking amount of the first white sand layer S2 and the second white sand layer S4 becomes greater.

As described above, the cable housing container 1 according to the present embodiment includes the container body 10 provided with the bottom portion 11 and the pair of side wall portions 12 extending upward from both sides in the width direction of the bottom portion 11 and having the opening 10a formed on the upper surface thereof, the container body 10 being made of resin and being adapted to be buried in the ground. Each of the pair of side wall portions 12 of the container body 10 has, on its outer surface, the overhanging portion 14 that is formed on an upper portion of the outer surface and overhangs outward in the width direction of the container body 10 relative to a lower portion of the outer surface, and the plurality of reinforcing ribs 15 that are formed below the overhanging portion 14 and spaced apart from each other in a horizontal direction, each of the reinforcing ribs protruding outward in the width direction and extending in the top-bottom direction. The overhanging portion 14 has, on its lower portion, the inclined surface 14a formed in such a manner as to gradually downwardly decrease in the outward overhang amount in the width direction of the container body 10.

Thereby, the force of the compaction machine C is transmitted obliquely downward along the inclined surface, and thus the sand and the gravel located below the overhanging portion 14 are compacted by the compaction machine C, whereby it is possible to reliably perform compaction around the container body 10, and to suppress subsidence of the ground around the container body after the installation.

Preferably, the inclined surface 14a has the angle α of 45° or less with respect to the vertical direction V.

Thereby, the force of the compaction machine C can be reliably transmitted to the sand and the gravel located below the overhanging portion 14, and thus it is possible to more reliably perform compaction around the container body 10.

Preferably, the reinforcing rib 15 has the width that gradually decreases toward the end in the protruding direction.

Thereby, the sand and the gravel are likely to enter both outer sides in the width direction of the reinforcing rib 15, and thus it is possible to more reliably perform compaction around the container body 10.

Preferably, the distance D between the reinforcing ribs adjacent to each other is three times or more the protruding amount P of the reinforcing rib 15.

Thereby, the force of the compaction machine C can be reliably transmitted to the sand and the gravel located between the reinforcing ribs 15 of the side wall portion 12, and thus it is possible to more reliably perform compaction around the container body 10.

Preferably, the cable housing container includes the lid 20 that closes the opening 10a of the container body 10, each of the pair of side wall portions 12 of the container body 10 has a lid receiving portion 13 that receives the lid 20, and the lid receiving portion 13 is formed inward in the width direction relative to the overhanging portion 14.

Thereby, the thickness of the members can be made uniform over the entire container body 10, and thus it is possible to prevent distortion of the container body 10 molded from the resin.

The above-described embodiment shows the cable housing container to be buried in the road paved with asphalt, but a cable housing container buried in the ground of the road surface not paved with asphalt is also applicable as long as being buried in the ground of a road surface on which heavy objects such as vehicles pass.

Further, the above-described embodiment shows that the side wall portions 12 of the container body 10 extend in the vertical direction, but the present invention is applicable to a container body including not only the side wall portions extending in the vertical direction but also side wall portions extending obliquely upward. Even in such a case, it is preferable that the inclined surface on the lower portion of the overhanging portion of the side wall portion has an angle of 45° or less with respect to the axis in the vertical direction.

### EXPLANATION OF REFERENCE NUMERALS

1: cable housing container
10: container body
10a: opening
11: bottom portion
12: side wall portions
13: lid receiving portion
14: overhanging portion
14a: inclined surface
15: reinforcing rib
20: lid

1. A cable housing container comprising:
a container body including a bottom portion and a pair of side wall portions extending upward from both sides in a width direction of the bottom portion and having an opening formed on an upper surface thereof, the container body being made of resin and being adapted to be buried in a ground, wherein
each of the pair of side wall portions of the container body has, on an outer surface thereof, an overhanging portion that is formed on an upper portion of the outer surface and overhangs outward in the width direction of the container body relative to a lower portion of the outer surface, and
a plurality of reinforcing ribs that are formed below the overhanging portion and spaced apart from each other in a horizontal direction, each of the reinforcing ribs protruding outward in the width direction and extending in a top-bottom direction, and
the overhanging portion has, on a lower portion thereof, an inclined surface formed in such a manner as to gradually downwardly decrease in an outward overhang amount in the width direction of the container body.

2. The cable housing container according to claim 1, wherein
the inclined surface has an angle of 45° or less with respect to a vertical direction.

3. The cable housing container according to claim 1, wherein
each of the reinforcing ribs has a width that gradually decreases toward an end in a protruding direction.

4. The cable housing container according to claim 1, wherein
a distance between the reinforcing ribs adjacent to each other is three times or more a protruding amount of the reinforcing ribs.

5. The cable housing container according to claim 1, further comprising:
a lid that closes the opening of the container body, wherein
each of the pair of side wall portions of the container body has a lid receiving portion that receives the lid, and the lid receiving portion is formed inward in the width direction relative to the overhanging portion.
